(19) United States
(12) Patent Application Publication
(10) Pub. No.: US 2006/0053217 A1
(43) Pub. Date: Mar. 9, 2006

(54) Information processing apparatus, transfer program product, and transfer control method

(76) Inventors: Tatsumi Nagasawa, Tokyo (JP); Akira Tanamura, Tokyo (JP)

Correspondence Address: LAW OFFICES OF MICHAEL DRYJA, 704 228TH AVE NE, #694, SAMMAMISH, WA, 98074, US

(21) Appl. No.: 11/219,624

(22) Filed: Sep. 3, 2005

(30) Foreign Application Priority Data
Sep. 7, 2004 (JP) JP2004-260199

(51) Int. Cl. G06F 15/173

(52) U.S. Cl. 709/223

(57) ABSTRACT

An information processing apparatus from which setting information for setting up an operating environment is transferred to another information processing apparatus includes a logged-in user setting information expanding unit, and a non-logged-in user setting information expanding unit. The logged-in user setting information expanding unit reads setting information of a logged-in user from a setting information storage file in which the setting information is stored, and expands the setting information in an area of a memory space in which a setting for the information processing apparatus is stored. The non-logged-in user setting information expanding unit reads setting information of a non-logged-in user from the setting information storage file, and expands the setting information in an area of the memory space other than the area in which the setting information of the logged-in user has been stored.

### RELATED APPLICATIONS

The present patent application claims priority under 35 USC 119 to the previously filed Japanese (JP) patent application entitled “Information processing apparatus, transfer program product, and transfer controlling method,” filed on Sep. 7, 2004, and assigned serial no. 2004-260199 [attorney docket no. JP920040127JP1].

### FIELD OF THE INVENTION

The present invention relates generally to an information processing apparatus, a transfer program product, and a transfer control method. More particularly, the present invention relates to transferring the operating environment of a user from one information processing apparatus to another, and a corresponding such transfer program product and transfer control method.

### BACKGROUND OF THE INVENTION

LANs (local area networks) connecting many personal computers to each other are commonly used in enterprises and other environments. While personal computers have become more sophisticated, they are still technologically advancing rapidly. As a result, personal computers still have to be replaced with newer machines relatively often. An administrator who is responsible for replacing computers with newer machines usually has to ensure that the process will occur smoothly. When a large number of machines are replaced, the operational burden on the administrator can be enormous.

One technology that has been used to transfer setting information of an operating environment for a user between an old information processing apparatus a new information processing apparatus is described in Japanese Published Unexamined Patent Application No. 2003-44560. Software has been accordingly developed to transfer the setting information of the operating environment for a user between information processing apparatuses, such as that described in “Introduction and User's Guide of System Migration Assistant,” available on the Internet at www-6.ibm.com/jp/pc/migration/sma/. According to these technologies, setting information to be transferred can be selected by the user. As a result, the amount of data that is transferred can be reduced, and unnecessary setting information does not have to be transferred.

For situations where a large number of personal computers are being replaced, such as on a LAN, a general practice for reducing the burden of the users is to assign an administrator to replace all these information processing apparatuses. In such instances, even when just one information processing apparatus is replaced, only the administrator may be responsible, such that the user of the information processing apparatus in question is not responsible.

According to the prior art technologies described in the preceding paragraphs, setting information can be selectively transferred for a user who has logged in the information processing apparatus from which the setting information is to be transferred. However, setting information cannot be selectively transferred for a user who has not logged in. Rather, all the setting information has to be transferred. To avoid unnecessary transfer of settings, the administrator has to input passwords of all the users who are having their information processing apparatuses replaced, which complicates the transfer process. Alternatively, where all the setting information is transferred, unnecessary data is likely to be transferred, which is also disadvantageous.

For these and other reasons, therefore, there is a need for the present invention.

### SUMMARY OF THE INVENTION

The present invention relates to an information processing apparatus, a transfer program product, and a transfer control method that can solve the problems described above. An information processing apparatus of one embodiment of the invention is that from which setting information for setting up an operating environment is transferred to another information processing apparatus. The information processing apparatus includes a logged-in user setting information expanding unit, a non-logged-in user setting information expanding unit, a transfer file writing unit, and a transfer setting information selecting unit. The logged-in user setting information expanding unit reads setting information of a logged-in user, and expands the setting information in a setting information storage area of a memory space.

The non-logged-in user setting information expanding unit reads setting information of a non-logged-in-user, and expands the setting information in an area of the memory space other than the setting information storage area. The transfer file writing unit writes at least a part of the setting information of the non-logged-in user as expanded into a transfer file in which the setting information to be transferred to another information processing apparatus is stored. The transfer setting information selecting unit selects, by user instruction, the setting information to be transferred to another information processing apparatus, among the setting information of the non-logged-in user as expanded.

A system of an embodiment of the invention includes a first information processing apparatus, a second information processing apparatus, a logged-in user setting information mechanism, and a non-logged-in user setting information mechanism. The first information processing apparatus has setting information for both a logged-in user and a non-logged-in-user to be transferred to the second information processing apparatus. The logged-in user setting information mechanism is to read the setting information of the logged-in user and to expand this setting information in a setting information storage area in a memory space. The non-logged-in user setting information mechanism is to read setting information of the non-logged-in user and to expand this setting information in an area in the memory space other than the setting information storage area.

A transfer control method of an embodiment of the invention is for controlling an information processing apparatus from which setting information for setting up an operating environment is transferred to another information processing apparatus. The method reads setting information of a logged-in user of the information processing apparatus from a setting information storage file, and expands this information into a first area of a memory space. The method reads setting information of a non-logged-in user of the information processing apparatus from the setting information storage file, and expands this information into a second area of the memory space. The method writes at least a part of the setting information of the non-logged-in-user as expanded into a transfer file in which the setting information is stored.

An article of manufacture of an embodiment of the invention includes a computer-readable medium and means in the medium. The computer-readable medium may be a recordable data storage medium, a modulated carrier signal, or another type of computer-readable medium. The means is for reading setting information of a logged-in user of an information processing apparatus, and for reading setting information of a non-logged-in user of an information processing apparatus. The means is further for expanding the setting information of the logged-in user and the setting information of the non-logged-in user into different areas of memory.

Still other aspects and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 shows a configuration of an information processing apparatus, according to an embodiment of the invention.

FIG. 2 shows a form of setting information storage files stored in a hard disk drive, according to an embodiment of the invention.

FIG. 3 shows an example of a data structure of a setting information storage area, according to an embodiment of the invention.

FIG. 4 shows an example of processing by an operating system, according to an embodiment of the invention.

FIG. 5 shows an example of processing by a transfer program, according to an embodiment of the invention.

FIG. 6 shows an example of a hardware configuration of an information processing apparatus, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

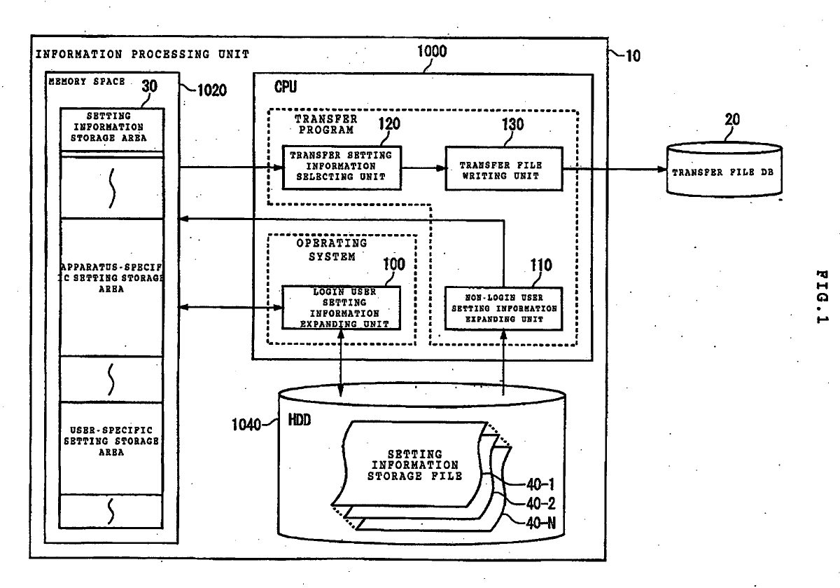

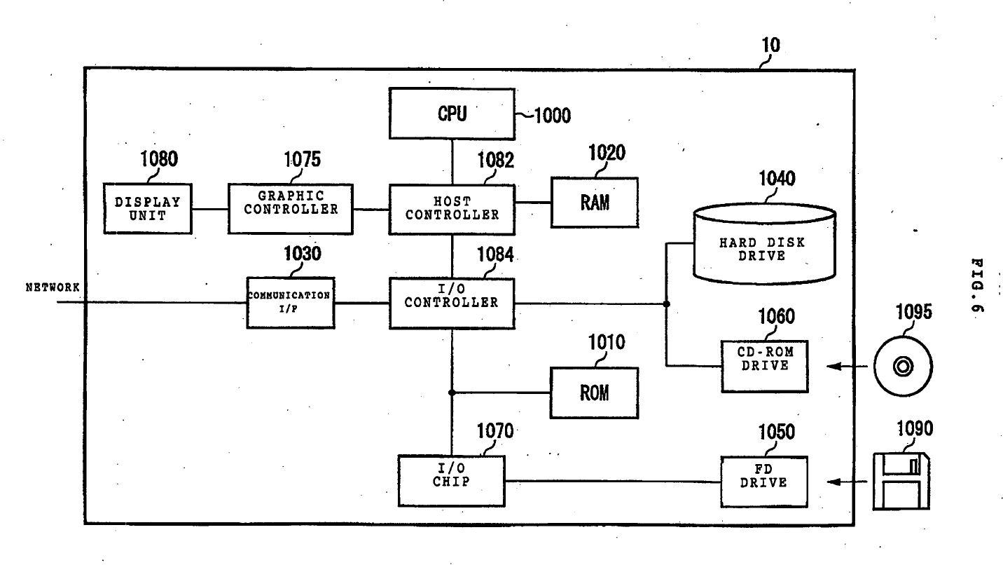

FIG. 1 shows a configuration of an information processing apparatus 10, according to an embodiment of the invention. The information processing apparatus 10 is an information processing apparatus from which setting information for setting up an operating environment for each user is transferred to another information processing apparatus. The information processing apparatus 10 is intended to selectively read setting information of a user and write the information into a transfer file DB20 even when the user does not log in. The information processing apparatus 10 includes a central processing unit (CPU) 1000, a random-access memory (RAM) 1020, and a hard disk drive 1040. Details of a hardware configuration of the information processing apparatus 10 will be described later in the detailed description, in reference to FIG. 6. Thus, FIG. 1 shows only a minimum configuration for explaining functions of the information processing apparatus 10.

The CPU 1000 functions as a logged-in user setting information expanding unit 100 with an operating system. Moreover, the CPU 1000 functions as a non-logged-in user setting information expanding unit 110, a transfer setting information selecting unit 120, and a transfer file writing unit 130 with a transfer program for transferring the setting information.

The logged-in user setting information expanding unit 100 reads setting information of a logged-in user, who has logged in the information processing apparatus 10, from setting information storage files 40-1 to 40-N storing setting information for each user. The logged-in user setting information expanding unit 100 expands the read setting information in a setting information storage area 30 in a memory space within the RAM 1020 storing a setting for the information processing apparatus 10. To be more specific, the logged-in user setting information expanding unit 100 expands the read setting information in a user-specific setting storage area within the setting information storage area. In the user-specific setting storage area, settings specific to respective logged-in users are stored. The CPU 1000 writes the setting information expanded in the user-specific setting storage area back into the hard disk drive 1040 if necessary.

The non-logged-in user setting information expanding unit 110 selects and reads setting information of a non-logged-in user, who has not logged in, from the setting information storage files 40-1 to 40-N. Thereafter, the non-logged-in user setting information expanding unit 110 expands the read setting information in an area of the memory space other than the user-specific setting storage area in which the setting information of the logged-in user is stored. For example, the non-logged-in user setting information expanding unit 110 may expand the read setting information in an apparatus-specific setting storage area within the setting information storage area 30. In the apparatus-specific setting storage area, a setting specific to the information processing apparatus 10 is stored.

The transfer setting information selecting unit 120 selects setting information to be transferred to another information processing apparatus from the setting information of the non-logged-in users that is expanded by the non-logged-in user setting information expanding unit 110, for example, by an instruction of a user having an administrator authority. The transfer file writing unit 130 writes into a transfer file the setting information selected by the transfer setting information selecting unit 120 from the setting information of the non-logged-in user, which is expanded by the non-logged-in user setting information expanding unit 110. In the transfer file, setting information to be transferred to another information processing apparatus is stored. The transfer file writing unit 130 stores the transfer file in the transfer file DB 20.

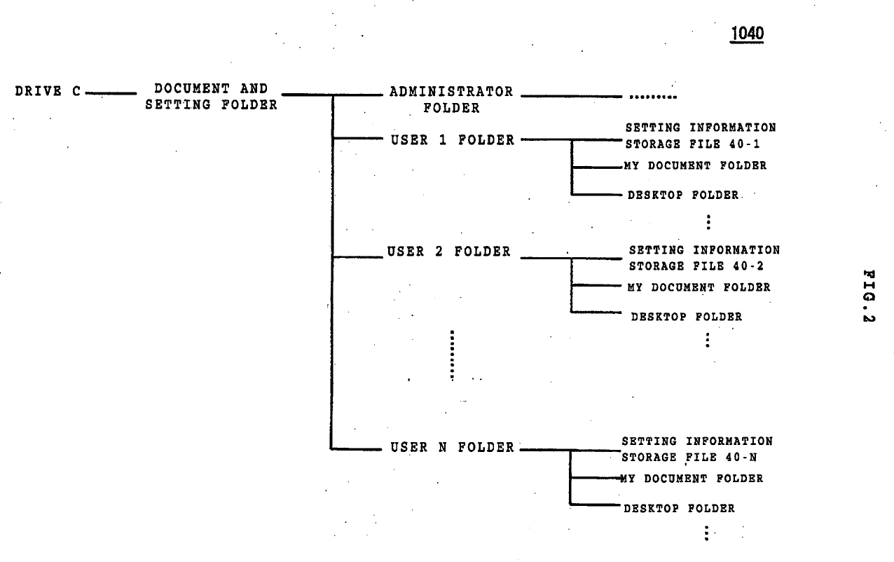

FIG. 2 shows a form of the setting information storage files 40-1 to 40-N stored in the hard disk drive 1040, according to an embodiment of the invention. The hard disk drive 1040 manages files and folders storing the files in a hierarchy structure. Specifically, the hard disk drive 1040 includes a document and a setting folder within a logical drive with a volume label C. The hard disk drive 1040 further includes a number of folders that are assigned for individual users and store files specific to the individual users within the document and the setting folder. Specifically, the hard disk drive 1040 includes an administrator folder, a user 1 folder, a user 2 folder, and a user N folder.

The hard disk drive 1040 includes the setting information storage file 40-1, a my document folder, and a desktop folder within the user 1 folder. The setting information storage file 40-1 is a file in which setting information for setting up an operating environment of a user 1 is stored. When the user 1 logs in the information processing apparatus 10, the logged-in user setting information expanding unit 100 reads the setting information for setting up the operating environment of the user 1 from the setting information storage file 40-1 and stores the information in the user-specific setting information storage area within the memory space.

When the user 1 logs in the information processing apparatus 10, files and folders in the desktop folder are displayed as icons on an initial screen, such as a desktop screen, after login. When an icon of the my document folder of the user 1 is selected, files and folders in the my document folder are displayed as icons. Processing in the case where users 2 to N log in is the same as that in the case where the user 1 logs in, and description thereof is therefore omitted.

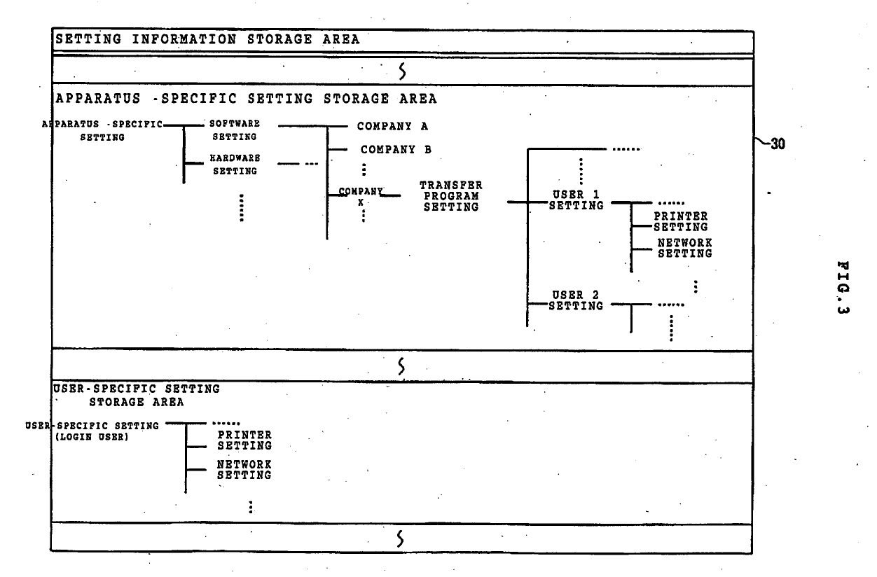

FIG. 3 shows an example of a data structure of the setting information storage area 30, according to an embodiment of the invention. The setting information storage area 30 includes the apparatus-specific setting storage area in which the setting information specific to the information processing apparatus 10 is stored and the user-specific setting storage area in which the setting information specific to the logged-in users who have logged in the information processing apparatus 10 is stored. The setting information in this embodiment is, for example, a registry in a Microsoft Windows® operating system. The setting information is referred to and/or edited by application programs through various types of application programming interfaces (APIs) provided by the operating system.

The RAM 1020 manages various types of setting information in a hierarchical fashion in each of the apparatus-specific setting storage area and the user-specific setting storage area. Specifically, in a level under the apparatus-specific setting at the topmost level, software settings, hardware settings, and the like are managed. In a level under the level of the software settings, software settings of respective companies are managed for each distributor of the software. For example, in a level under a company X setting, the setting of the transfer program for transferring the setting information to another information processing apparatus is managed. In a level under the level of the user-specific setting at the topmost level of the user-specific setting information, various types of settings of a user who has currently logged in, for example, settings for a printer and a network of the user are managed.

As an example, in the Windows® operating system, the registry is indicated as a set of setting items (called keys) specifying the operating environment of the information processing apparatus 10. For example, the apparatus-specific setting is managed as a key called HkeyLocalMachine, whereas the user-specific setting is managed as a key called HKeyCurrentUser. The software setting in the apparatus-specific setting is managed as a key called HkeyLocalMachine/SOFTWARE.

With reference to FIG. 3, description will be given of expanding processing of setting information by the logged-in user setting information expanding unit 100 and the non-logged-in user setting information expanding unit 110. When a user logs in, the logged-in user setting information expanding unit 100 expands the setting information for the logged-in user in the level under the user-specific setting within the user-specific setting storage area regardless of whether or not the logged-in user has an administrator authority. Specifically, the logged-in user setting information expanding unit 100 manages the printer and network settings of the logged-in user under the level of the user-specific setting.

On the other hand, the non-logged-in user setting information expanding unit 110 reads the setting information storage file of the non-logged-in users, which can be read only by an administrator, under a condition that a user having the administrator authority has logged in. The non-logged-in user setting information expanding unit 110 expands the setting information of the non-logged-in users in the apparatus-specific setting storage area in which only the administrator can write. For example, the non-logged-in user setting information expanding unit 110 may expand setting information of users who have not logged in for each user under the level of the setting for the transfer program.

As described above, the setting information of the non-logged-in users is expanded in a predetermined area of the setting information storage area other than an area in which the setting information of the logged-in users is expanded and has the same structure as that in the case where the non-logged-in users log in. Thus, the setting information of the non-logged-in users can be edited by various types of APIs of the operating system in the same manner as the setting information of the logged-in users. Consequently, the transfer setting information selecting unit 120 can efficiently select the setting information to be transferred to another information processing apparatus by use of the APIs described above.

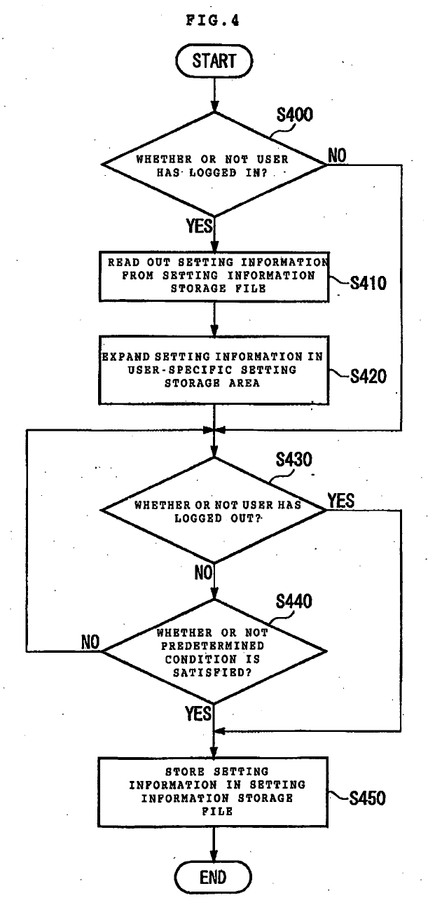

FIG. 4 shows an example of processing by the operating system, according to an embodiment of the invention. The information processing apparatus 10 performs the following processing in cooperation with the operating system, for example, periodically or when needed. When a user logs in (S400: YES), the logged-in user setting information expanding unit 100 selects the setting information storage file corresponding to the logged-in user from the setting information storage files 40-1 to 40-N and reads the setting information from the selected setting information storage file (S410). Next, the logged-in user setting information expanding unit 100 expands the read setting information in the user-specific setting storage area (S420).

When the user logs out (S430: YES) or when a predetermined condition is satisfied (S440: YES), the information processing apparatus 10 saves the expanded setting information in the setting information storage file. For example, the information processing apparatus 10 may save the setting information every predetermined period of time or may save the setting information each time the expanded setting information is changed.

As described above, the setting information is read from the file and expanded in the memory by the operating system each time the user logs in. In the case where the user logs out and the like, the setting information is written back into the file. Consequently, the setting of the logged-in user is expanded in the memory so as to be accessed at high speed. Moreover, the setting of the non-logged-in user is withdrawn from the memory, thus reducing an occupied area of the memory.

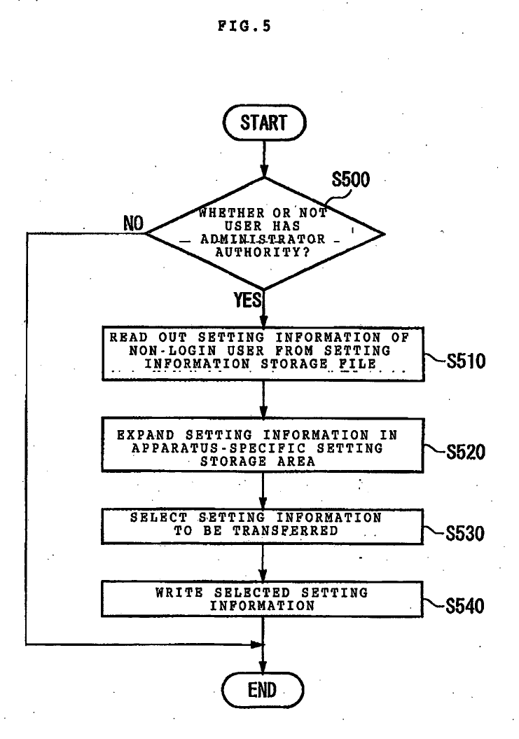

FIG. 5 shows an example of processing by the transfer program, according to an embodiment of the invention. The information processing apparatus 10 performs the following processing in cooperation with the transfer program upon receiving a transfer instruction for instructing processing of transferring the setting information to another information processing apparatus. When the logged-in user has the administrator authority (S500: YES), the non-logged-in user setting information expanding unit 110 reads the setting information of the non-logged-in users from the setting information storage files 40-1 to 40-N (S510). The non-logged-in user setting information expanding unit 110 expands the read setting information in the apparatus-specific setting storage area (S520).

Next, the transfer setting information selecting unit 120 selects, by an instruction of the user, the setting information to be transferred to another information processing apparatus from the expanded setting information of the non-logged-in users (S530). Next, the transfer file writing unit 130 writes the selected setting information of the non-logged-in user into the transfer file within the transfer file DB 20 (S540). Furthermore, the transfer file writing unit 130 may write the setting information specific to the information processing apparatus 10, which is managed within the apparatus-specific setting storage area, into the transfer file in order to transfer the information to another information processing apparatus.

According to this embodiment, if only one user having the administrator authority logs in, operating environments of all users can be read and selectively stored in the file without making other users log in. Thus, the burden on an operator in charge of transferring the setting information can be considerably reduced. At the same time, a data size of the transfer file can be reduced by selecting only the setting information required for transfer.

FIG. 6 shows an example of a hardware configuration of the information processing apparatus 10, according to an embodiment of the invention. The information processing apparatus 10 includes a CPU peripheral unit, an input/output (I/O) unit, and a legacy I/O unit. The CPU peripheral unit includes the CPU 1000, the RAM 1020, and a graphic controller 1075 which are connected to each other by a host controller 1082. The I/O unit includes a communication interface 1030, the hard disk drive 1040, and a CD-ROM drive 1060 which are connected to the host controller 1082 by an I/O controller 1084. The legacy I/O unit includes a basic input/output system (BIOS) 1010, a floppy disk drive 1050, and an I/O chip 1070 which are connected to the I/O controller 1084.

The host controller 1082 connects the RAM 1020, CPU 1000 and the graphic controller 1075 which access the RAM 1020 at a high transfer rate. The CPU 1000 operates based on programs stored in the BIOS 1010 and the RAM 1020 to control the respective units. The graphic controller 1075 acquires image data which is created by the CPU 1000 or the like in a frame buffer provided in the RAM 1020 and displays the data on a display unit 1080. Instead, the graphic controller 1075 may internally include the frame buffer storing the image data created by the CPU 1000 or the like.

The I/O controller 1084 connects the host controller 1082 to the communication interface 1030, the hard disk drive 1040, and the CD-ROM drive 1060, which are relatively high-speed I/O devices. The communication interface 1030 communicates with external devices through a network. The hard disk drive 1040 stores programs and data used by the information processing apparatus 10. The CD-ROM drive 1060 reads a program and data from a CD-ROM 1095 and provides the program and the data to the I/O chip 1070 through the RAM 1020.

The I/O controller 1084 is connected to the BIOS 1010 and relatively low-speed I/O devices such as the floppy disk drive 1050 and the I/O chip 1070. The BIOS 1010 stores a boot program executed by the CPU 1000 when the information processing apparatus 10 is activated, a program depending on the hardware of the information processing apparatus 10, and the like. The floppy disk drive 1050 reads a program or data from a floppy disk 1090 and provides the program or the data to the I/O chip 1070 through the RAM 1020. The I/O chip 1070 connects the various I/O devices to each other through the floppy disk 1090 and, for example, a parallel port, a serial port, a keyboard port, a mouse port, and the like.

The programs provided to the information processing apparatus 10 are stored in a storage medium such as the floppy disk 1090, the CD-ROM 1095 and an integrated circuit (IC) card and are provided by a user. The programs are read from the storage medium through the I/O chip 1070 and/or the I/O controller 1084 and installed in the information processing apparatus 10 to be executed. Operations which the programs cause the information processing apparatus 10 and the like to perform are the same as those in the information processing apparatus 10 described in FIGS. 1 to 5, and description thereof is thus omitted.

The programs described above may be stored in an external storage medium. As the storage medium, in addition to the floppy disk 1090 and the CD-ROM 1095, an optical storage medium such as a DVD and a PD, a magneto-optical storage medium such as a MD, a tape medium, a semiconductor memory such as an IC card, and the like can be used. Moreover, the programs may be provided to the information processing apparatus 10 through the network by using, as the storage medium, a storage device, such as a hard disk and a RAM, which is provided in a server system connected to a dedicated communication network or the Internet.

Although the present invention has been described above in relation to a specific embodiment, the technical scope of other embodiments of the present invention is not limited to the scope described in the above embodiment. It will be apparent to those skilled in the art that various modifications or improvements can be made to the embodiment described above. It is further apparent from the description of claims that embodiments with such modifications and improvements can also be included in the technical scope of the present invention. For instance, even when a user does not log in an information processing apparatus from which setting information is transferred, an embodiment of the present invention may enable the setting information of the user to be read selectively. Thus, although the preferred embodiment of the present invention has been described in detail, it should be understood that various changes, substitutions and alternations can be made therein without departing from spirit and scope of the invention as defined by the appended claims.

What is claimed is:

1. An information processing apparatus, from which setting information for setting up an operating environment is transferred to another information processing apparatus, comprising:
a logged-in user setting information expanding unit to read setting information of a logged-in user of the information processing apparatus, and to expand the setting information in a setting information storage area of a memory space; and,
a non-logged-in user setting information expanding unit to read setting information of a non-logged-in user of the information processing apparatus, and to expand the setting information in an area of the memory space other than the setting information storage area.

2. The information processing apparatus of claim 1, wherein the logged-in user setting information expanding unit is to read the setting information of the logged-in user from a setting information storage file in which information for the logged-in user has been stored.

3. The information processing apparatus of claim 1, wherein the non-logged-in user setting information expanding unit is to read the setting information of the non-logged-in user from a setting information storage file in which information for the non-logged-in user has been stored.

4. The information processing apparatus of claim 1, further comprising a transfer file writing unit to write at least a part of the setting information of the non-logged-in user as expanded to a transfer file in which the setting information of the non-logged-in user to be transferred to another information processing apparatus is stored.

5. The information processing apparatus of claim 1, wherein the non-logged-in user setting information expanding unit expands the setting information of the non-logged-in user in a portion of the setting information storage area other than a portion in which the setting information of the logged-in user is stored.

6. The information processing apparatus of claim 1, further comprising a transfer setting information selecting unit to select, by instruction of a user, the setting information to be transferred to another information processing apparatus among the setting information of the non-logged-in user as expanded by the non-logged-in user setting information expanding unit.

7. The information processing apparatus of claim 6, further comprising a transfer file writing unit to writes to a transfer file the setting information selected by the transfer setting information selecting unit among the setting information of the non-logged-in user expanded by the non-logged-in user setting information expanding unit.

8. The information processing apparatus of claim 1, wherein the logged-in user setting information expanding unit expands the setting information of the logged-in user in the setting information storage area regardless of whether the logged-in user has administrator authority.

9. The information processing apparatus of claim 8, wherein the non-logged-in user setting information expanding unit reads the setting information of the non-logged-in user from the setting information storage file readable by an administrator and expands the setting information in the area in the memory space where a user having administrator authority has logged in.

10. A system comprising:
a first information processing apparatus having setting information of a logged-in user and setting information of a non-logged-in user to be transferred;
a second information processing apparatus to which the setting information is to be transferred from the first information processing apparatus;
a logged-in user setting information mechanism to read the setting information of the logged-in user of the first information processing apparatus and to expand the setting information in a setting information storage area in a memory space; and,
a non-logged-in user setting information mechanism to read the setting information of the non-logged-in user of the first information processing apparatus and to expand the setting information in an area in the memory space other than the setting information storage area.

11. The system of claim 10, further comprising a transfer setting information selecting mechanism to select, by instruction of a user, the setting information to be transferred to another information processing apparatus among the setting information of the non-logged-in user as expanded by the non-logged-in user setting information mechanism.

12. The system of claim 10, wherein the logged-in user setting information mechanism is to read the setting information of the logged-in user from a setting information storage file in which the setting information for the logged-in user has been stored.

13. The system of claim 10, wherein the non-logged-in user setting information mechanism is to read the setting information of the non-logged-in user from a setting information storage file in which information for the non-logged-in user has been stored.

14. A transfer controlling method for controlling an information processing apparatus from which setting information for setting up an operating environment is transferred to another information processing apparatus, the method comprising:
reading setting information of a logged-in user of the information processing apparatus from a setting information storage file;
expanding the setting information of the logged-in user in a first area of a memory space;
reading setting information of a non-logged-in user of the information processing apparatus from the setting information storage file;
expanding the setting information in a second area of the memory space; and,
writing at least a part of the setting information of the non-logged-in user as expanded to a transfer file in which the setting information is stored.

15. The method of claim 14, further comprising selecting, by a user, the setting information to be transferred to another information processing apparatus among the setting information of the non-logged-in user as expanded.

16. The method of claim 15, further comprising writing to the transfer file the setting information selected by the user.

17. An article of manufacture comprising:
a computer-readable medium; and,
means in the medium for reading setting information of a logged-in user of an information processing apparatus and reading setting information of a non-logged-in user of the information processing apparatus, and for expanding the setting information of the logged-in user and the setting information of the non-logged-in user to different areas of memory.

18. The article of manufacture of claim 17, wherein the means is further for writing at least a part of the setting information of the non-logged-in user as expanded to a transfer file.

19. The article of manufacture of claim 17, wherein the means is to read the setting information of the logged-in user from a setting information storage file and is to read the setting information of the non-logged-in user from the setting information storage file.

20. The article of manufacture of claim 17, wherein the means is further for permitting a user to select the setting information to be transferred among the setting information of the non-logged-in user as expanded.
